(19) United States
(12) Patent Application Publication
(10) Pub. No.: US 2005/0011889 A1
(43) Pub. Date: Jan. 20, 2005

(54) Heating device

(76) Inventor: Jan Przybyla, Chelmsford (GB)

Correspondence Address: VENABLE, BAETJER, HOWARD AND CIVILETTI, LLP, P.O. BOX 34385, WASHINGTON, DC, 20043-9998, US

(21) Appl. No.: 10/491,952

(22) PCT Filed: Oct. 8, 2002
(86) PCT No.: PCT/GB02/04586

(30) Foreign Application Priority Data
Oct. 8, 2001 (GB) 0124104.1

(51) Int. Cl. H05B 6/62

(52) U.S. Cl. 219/765

(57) ABSTRACT

Heating devices are typically used in glue guns to soften adhesives. A conventional glue gun employs a resistive element to generate heat energy. The invention provides a glue gun comprising an amplifier (2) in communication with a capacitor (7). The amplifier is arranged to supply a.c. power at a predetermined frequency to plates (8, 9), of the capacitor. Adhesive (10) is introduced between the capacitor plates an is softened by dielectric heating.

This invention relates to heating devices and to methods of using such devices to heat, for example, adhesive materials.

Certain adhesive materials need to be softened by heating for use. The two main types of such adhesives are thermoplastic adhesives and thermosetting adhesives. Thermoplastic adhesives can be softened any number of times by heating. Upon cooling, they once again adhere. Thermosetting adhesives undergo an irreversible chemical change when they harden. After setting, these adhesives retain their strength and do not soften when heated.

Conventionally, a so-called glue gun is used to soften and apply such adhesives. A typical glue gun employs a resistive element used to convert electrical energy to heat energy, to heat the adhesive.

The invention provides heating apparatus comprising an amplifier in communication with a capacitor, the amplifier being arranged, in use, to supply power to plates of the capacitor, between which plates a substance to be heated may be introduced.

The invention has particular application in the softening by heating of adhesives. Accordingly, the invention further provides a glue gun comprising an amplifier in communication with a capacitor, the amplifier being arranged, in use, to supply power to plates of the capacitor, between which plates an adhesive to be softened may be introduced.

Advantageously, the amplifier includes an active device, such as a transistor, arranged to perform substantially as a switch.

Preferably, the active device is driven so that the amplifier produces a.c. power at a predetermined frequency. A Class E type amplifier is particularly suitable for putting the invention into effect.

Preferably, the capacitor is part of a resonance circuit, i.e. a circuit incorporating an appropriate inductor.

The invention will now be described, by way of example, with reference to the accompanying drawings, in which:

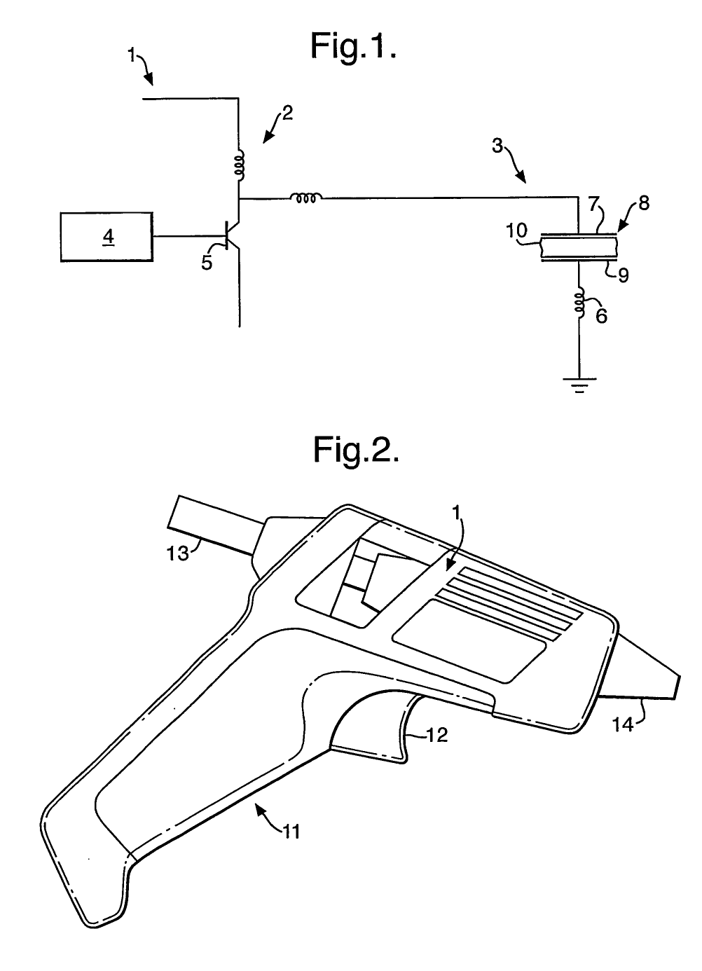

FIG. 1 is a schematic circuit diagram for apparatus constructed according to the invention; and

FIG. 2 illustrates a glue gun employing the circuit of FIG. 1.

With reference to FIG. 1, a circuit constructed according to the invention is shown and indicated generally by the reference numeral 1. The circuit 1 comprises two main parts: a power amplifier 2 and a load 3 for the amplifier.

The power amplifier 2 comprises a driver 4, which controls an active device. In this embodiment, the active device is in the form of a power transistor 5. The transistor 5 acts substantially as a switch when appropriately driven by the driver 4. Thus dc energy from a power supply (not shown) is converted into ac energy at the switching frequency. The output ac power is coupled to the load 3.

The load 3 comprises a coil 6 and a capacitor 7, which together form a series resonance circuit The capacitor 7 has plates 8, 9, between which a sample 10 of a substance to be heated is introduced. The sample 10 thus forms the dielectric of the capacitor 7. The capacitance of the capacitor 7, and hence the resonant frequency of the load 3, is dependent on the dielectric constant of the substance between the plates 8,9. Thus, the choice of substance to be heated influences the frequency that the power amplifier 2 has to produce in order to generate resonance in the load 3.

In use the power amplifier 2 delivers power, switched at a high frequency, to the load 3. Thus, the sample 10 is subjected to a high-frequency alternating current field that produces heat in the sample resulting from molecular friction. In this manner, the sample 10 is heated by the apparatus of the invention.

The circuitry of FIG. 1 is particularly suitable for use in softening adhesives, and so may be usefully incorporated in a glue gun, such as is shown in FIG. 2.

The glue gun, indicated generally by the reference numeral 11, incorporates the circuit 1. The gun also includes a trigger 12 for drawing adhesive 13 in stick form into the gun. There are also guides (not shown) inside the gun for guiding the adhesive stick 13 into place between the plates 8,9 of the capacitor 7. In use, the adhesive is softened by dielectric heating and is then drawn from a nozzle 14 for application to parts to be adhered.

Preferably, the amplifier is of the Class E type.

The power amplifier is arranged to deliver power at a predetermined frequency, which frequency produces dielectric heating of the substance, e.g. adhesive, between the capacitor plates. Thus, if a user inserts between the plates a substance having a different dielectric constant, no dielectric heating occurs owing to the different resonant frequency. This is an important safety feature.

The invention is not limited to heating adhesives, and may be applied to drying, cooking and other similar processes involving dielectric heating.

1. Heating apparatus comprising an amplifier in communication with a capacitor, the amplifier being arranged, in use, to supply power to plates of the capacitor, between which plates a substance to be heated may be introduced.

2. Apparatus as claimed in claim 1, in which the amplifier includes an active device arranged to perform substantially as a switch.

3. Apparatus as claimed in claim 2, in which the active device is a transistor.

4. Apparatus as claimed in claim 2, in which the active device is driven so that the amplifier produces a.c. power at a predetermined frequency.

5. Apparatus as claimed in claim 1, in which the amplifier is of the Class E type.

6. Apparatus as claimed in claim 1, in which the capacitor is part of a resonance circuit.

7. (Cancelled)

8. A glue gun including heating apparatus as claimed in claim 1, the substance being an adhesive to be softened by heating.

9. A glue gun as claimed in claim 8, further comprising means for introducing adhesive between the capacitor plates.

10. A glue gun as claimed in claim 9, in which the means for introducing adhesive includes a trigger.

11. A glue gun as claimed in claim 8, further comprising a nozzle arranged to deliver softened adhesive for use.

12. (Cancelled)

13. A method of heating a substance, comprising the steps of introducing the substance between the plates of a capacitor and supplying a.c. power to the capacitor by means of an amplifier.

14. A method of softening an adhesive, comprising the steps of introducing the adhesive between the plates of a capacitor and supplying a.c. power to the capacitor by means of an amplifier.
